(19) United States
(12) Patent Application Publication
(10) Pub. No.: US 2026/0270677 A1
(43) Pub. Date: Sep. 10, 2026

(54) MOBILE DEVICE CAPABILITY CHECK IN WIRELESS COMMUNICATION NETWORKS

(71) Applicant: T-Mobile USA, Inc., Bellevue, WA (US)

(72) Inventors: Kulandaivel Marappa Gounder, Bothell, WA (US); Kyeong Hun An, Sammamish, WA (US); Nilesh Ranjan, Sammamish, WA (US)

(21) Appl. No.: 19/073,955

(22) Filed: Mar. 7, 2025

(51) Int. Cl. H04W 8/20; H04W 8/24

(52) U.S. Cl. CPC H04W 8/20; H04W 8/24

(57) ABSTRACT

Techniques and architecture described herein provide an application (e.g., an applet) that is installed on a subscriber identity module (SIM) of a mobile device. The applet performs device profile requests from the mobile device, where the device profile includes at least capabilities of the mobile device. The obtained device profile may be stored in a server, e.g., mapped to the server. Logic may be used to process, e.g., analyze, the device profile in order to determine the mobile device's capability.

### BACKGROUND

Currently, mobile network operators (MNOs) are unable to verify whether a user's mobile device is capable of supporting specific services within the MNO's mobile network (also referred to herein as “wireless communication network”). It is especially difficult if the user's mobile device is not sold by the MNO and/or if the user brought their own mobile device for use within the mobile network. Without knowing a mobile device's capability, it is problematic for troubleshooting user complaints that may be related to the mobile device's operation within the mobile network.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 schematically illustrates an example block diagram of an architecture for a portion of a wireless communication network that for determines mobile communication device capabilities within the wireless communication network, according to some implementations.

FIG. 2 is a flow diagram illustrating an example method for determining mobile communication device capabilities within a wireless communication network, according to some implementations.

FIG. 3 schematically illustrates a component level view of an example mobile communication device configured for use with the techniques and architecture described herein, according to some implementations.

FIG. 4 schematically illustrates a component level view of a server configured for use with the techniques and architecture described herein, according to some implementations.

### DETAILED DESCRIPTION

Described herein are techniques and architecture that provide an application (e.g., an applet) that is installed on a subscriber identity module (SIM) card of a mobile device. The applet performs device profile requests from the mobile device, where the device profile includes at least capabilities of the mobile device. The obtained device profile may be stored in a server, e.g., mapped to the server. Logic may be used to process, e.g., analyze, the device profile in order to determine the mobile device's capability. Additionally, in configurations, a test suite may be run for every new mobile device launched within the mobile network in order to determine device capability matching the MNO's current requirements.

More particularly, a trusted application programming interface (API) server of the mobile network and/or a customer service entity, e.g., a customer service server, of the mobile network sends a mobile device capability call (request) to a quality of experience (QoE) server of the mobile network. Once the QoE server receives the request, the QoE server forwards the request to the applet on the SIM card on the mobile device. The applet sends a request to a controller of the mobile device for device profile information, which includes at least capabilities of the mobile device.

Once the applet receives the device profile information, the applet provides the device profile to the QoE server. The QoE server saves the device profile, e.g., maps the device profile with respect to the mobile device. The QoE server analyzes or processes the device profile in order to determine capabilities of the mobile device. The QoE server then sends the mobile device capabilities back to the API server and/or the customer service server.

In configurations, the steps of requesting the device profile information by the applet and providing the device profile information from the applet to the QoE server may be performed periodically without any external API server and/or customer service server making a request. These steps may be performed with a predetermined periodicity, e.g., daily, weekly, monthly, etc., in order to keep the mobile device's capabilities up to date in case of updates made to the mobile device, e.g., software updates, firmware updates, etc.

Thus, the SIM applet is capable of receiving device profile requests from a server, e.g., a QoE server. The SIM applet is capable of sending periodic device profile requests to a mobile device (user equipment (UE)) and is capable of sending on demand profile requests received from a server, e.g., a QoE server. The mobile device is capable of receiving such requests and sending the device profile to the applet. In configurations, the API server and/or the customer service server may send the request for the device profile directly to the applet. In configurations, two or more of the API server, the customer service server, and/or the QoE server may be implemented by a single server.

The applet may be installed on the physical SIM card (pSIM) of a mobile device or an embedded SIM (eSIM) of a mobile device. In configurations, the applet may be moved from an eSIM to another eSIM of another mobile device. In configurations, the applet may be installed on an integrated SIM (iSIM) of a mobile device. In configurations, the applet may be installed on pSIMs, eSIMs, and/or iSIMs over the air (OTA).

As previously noted, the SIM applet is capable of sending collected profile data to a server and the SIM applet is capable of sending immediate responses to the QoE server if the request is an on-demand request.

In configurations, the SIM applet receives the profile request and orders the mobile device to send the device profile to the SIM applet. The SIM applet collects the device profile data (information) and sends the device profile to the QoE server. The QoE server processes (maps) the data and determines the mobile device capabilities based on the mapping. The QoE server then provides the determined device capability to the API server (e.g., for engineering purposes) and/or the customer service server. The API server and/or the customer service server compares the mobile device capabilities to network requirements and makes business decisions with respect to the mobile device's operation within the mobile network. As previously noted, this capability check may be automated for new devices and/or for software and/or firmware updates before launch.

Accordingly, as an example, a method comprises providing, from an operator of a wireless communication network to a subscriber identity module (SIM) of an electronic device, an application. The method also comprises receiving, from a first server of the wireless communication network by the application, a request for a profile of the electronic device, wherein the profile comprises at least capabilities of the electronic device. The method further comprises based at least in part on the request, receiving, from the electronic device by the application, capabilities of the electronic device. The method additionally comprises forwarding, by the application to the first server, the profile.

In configurations, the method also comprises based at least in part on the profile, determining, by the first server, capabilities of the electronic device.

In some configurations, the first server comprises one of (i) a customer service of the wireless communication network server or (ii) an application programming interface (API) server.

In configurations, the method further comprises prior to the application receiving the request for the profile of the electronic device, receiving, by the first server from a second server of the wireless communication network, a request for capabilities of the electronic device.

In some configurations, the method further comprises forwarding, by the first server to the second server, capabilities of the electronic device.

In some configurations, the second server comprises one of (i) a customer service of the wireless communication network server or (ii) an application programming interface (API) server.

In configurations, the method further comprises receiving, from the first server of the wireless communication network by the application, the request for the profile of the electronic device, wherein the profile comprises at least capabilities of the electronic device; based at least in part on the request, receiving, from the electronic device by the application, capabilities of the electronic device; and forwarding, by the application to the first server, the profile.

In some configurations, the periodically performing occurs in a range of weekly to monthly.

As another example, a system comprises one or more processors; and one or more non-transitory computer-readable media storing computer-executable instructions that, when executed by the one or more processors, cause the one or more processors to perform actions. The actions comprise providing, from an operator of a wireless communication network to a subscriber identity module (SIM) of an electronic device, an application. The actions also comprise receiving, from a first server of the wireless communication network by the application, a request for a profile of the electronic device, wherein the profile comprises at least capabilities of the electronic device. The actions further comprise based at least in part on the request, receiving, from the electronic device by the application, capabilities of the electronic device. The actions additionally comprise forwarding, by the application to the first server, the profile.

Thus, the techniques and architecture described herein provide an application (e.g., an applet) that is installed on a subscriber identity module (SIM) of a mobile device. The applet performs device profile requests from the mobile device, where the device profile includes at least capabilities of the mobile device. The obtained device profile may be stored in a server, e.g., mapped to the server. Logic may be used to process, e.g., analyze, the device profile in order to determine the mobile device's capability. Accordingly, the MNO's customer service can gather mobile device capability and take needed actions with respect to the mobile device. Additionally, knowing a mobile device's capabilities simplifies business decision making and troubleshooting with respect to the mobile device and/or the mobile device's owner. Furthermore, in configurations, a test suite may be run for every new mobile device launched within the mobile network in order to determine device capability matching the MNO's current requirements. Additionally, the MNO can identify and take corrective action(s) if any new or existing mobile device has missing necessary capability.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

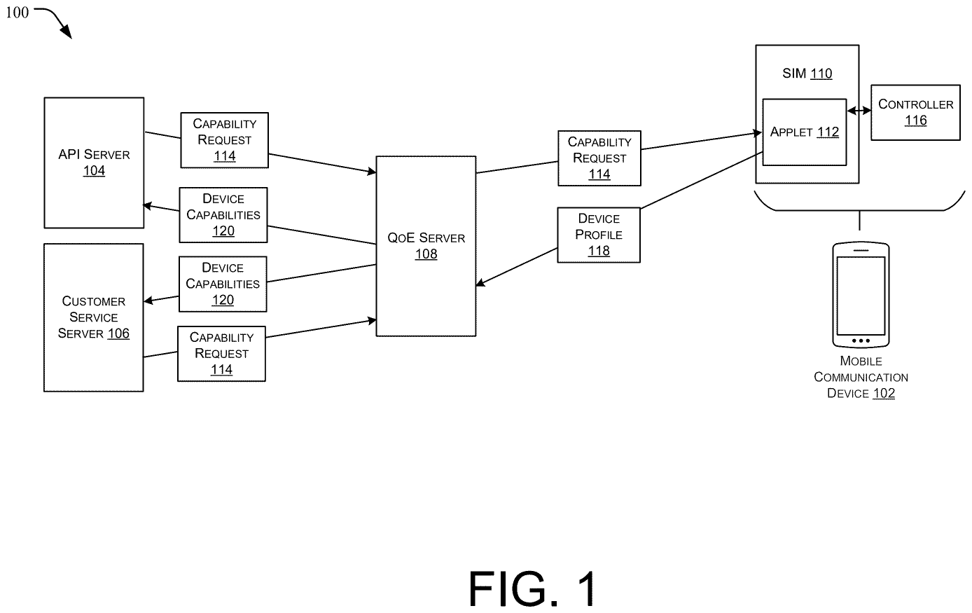

FIG. 1 schematically illustrates an example portion of a wireless communication network 100 (e.g., a mobile network). One or more mobile communication device(s) 102, e.g., a smart phone, a television, a smart appliance (e.g., an Internet of Things (IoT) device), a laptop, a tablet, a personal computer, etc., are configured to operate within the wireless communication network 100. The example portion of the wireless communication network 100 also includes a trusted application programming interface (API) server 104, a customer service entity, e.g., a customer service server 106, and a quality of experience (QoE) server 108. In configurations, the one or more mobile communication device(s) 102 each include a SIM 110 and an applet 112 loaded on the SIM. The applet 112 may be provided by an operator of the wireless communication network 100. The SIM 110 may in the form of a SIM card (pSIM), an embedded SIM (eSIM) or an integrated SIM (iSIM).

In configurations, the one or more mobile communication device(s) 102 may be implemented as any suitable mobile computing device configured to communicate over a wireless and/or wireline network, including, without limitation, a mobile phone (e.g., a smart phone), a tablet computer, a laptop computer, a portable digital assistant (PDA), a wearable computer (e.g., electronic/smart glasses, a smart watch, fitness trackers, etc.), a networked digital camera, and/or similar mobile devices. Although this description predominantly describes the one or more mobile communication device(s) 102 as being “mobile” (i.e., configured to be carried and moved around), it is to be appreciated that the one or more mobile communication device(s) 102 may represent various types of communication devices that are generally stationary as well, such as televisions, desktop computers, game consoles, set top boxes, Internet of Things (IoT) devices, and the like. In this sense, the terms “communication device,” “wireless device,” “wireline device,” “mobile communication device,” “mobile device,” “computing device,” “portable electronic device,” and “user equipment (UE)” may be used interchangeably herein to describe any communication device capable of performing the techniques described herein.

Furthermore, the one or more mobile communication device(s) 102 may be capable of communicating over wired networks, and/or wirelessly using any suitable wireless communications/data technology, protocol, or standard, such as Global System for Mobile Communications (GSM), Time Division Multiple Access (TDMA), Universal Mobile Telecommunications System (UMTS), Evolution-Data Optimized (EVDO), 4G Long Term Evolution (LTE), Advanced LTE (LTE+), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VoIP), Voice over LTE (VoLTE), 5G, 5G stand-alone (SA), IEEE 802.1x protocols, WiMAX, Wi-Fi, and/or any future IP-based network technology or evolution of an existing IP-based network technology.

In configurations, the API server 104 and/or the customer service server 106 sends a mobile device capability call (request) 114 to the QoE server 108 for a mobile communication device 102. Once the QoE server 108 receives the capability request 114, the QoE server 108 forwards the capability request 114 to the applet 112 on the SIM 110 on the mobile communication device 102. The applet 112 sends a request to a controller 116 of the mobile communication device 102 for a device profile 118, which includes at least capabilities of the mobile communication device 102.

Once the applet 112 receives the device profile 118, the applet 112 provides the device profile 118 to the QoE server 108. The QoE server 108 saves the device profile 118, e.g., maps the device profile 118 with respect to the mobile communication device 102. The QoE server 108 analyzes or processes the device profile 118 in order to determine device capabilities 120 of the mobile communication device 102. The QoE server 108 then sends the device capabilities 120 back to the API server 104 and/or the customer service server 106.

In configurations, the steps of requesting (capability request 114) the device profile 118 by the applet 112 and providing the device profile 118 from the applet 112 to the QoE server 108 may be performed periodically without any API server 104 and/or customer service server 106 making the request (e.g., capability request 114). These steps may be performed with a predetermined periodicity, e.g., daily, weekly, monthly, etc., in order to keep the mobile communication device's capabilities up to date in case of updates made to the mobile communication device 102, e.g., software updates, firmware updates, etc.

Thus, the applet 112 is configured to receive device capability requests 114 from a server, e.g., QoE server 108. The applet 112 is configured to send periodic device profile requests to a mobile communication device 102 and is configured to send on demand device profile requests 114 received from a server, e.g., QoE server 108. The mobile communication device 102 is capable of receiving such requests from the applet 112 and providing the device profile 118 to the applet 112. In configurations, the API server 104 and/or the customer service server 106 may send the capability request 114 for the device profile 118 directly to the applet 112. In configurations, two or more of the API server 104, the customer service server 106, and/or the QoE server 108 may be implemented by a single server.

The applet 112 may be provided by an operator of the wireless communication network 100. The applet 112 may be installed on a physical SIM card (pSIM) of the mobile communication device 102 or an embedded SIM (eSIM) of the mobile communication device 102. In configurations, the applet 112 may be moved from an eSIM to another eSIM of another mobile communication device. In configurations, the applet may be installed on an integrated SIM (iSIM) of the mobile communication device 102. In configurations, the applet 112 may be installed on pSIMs, eSIMs, and/or iSIMs over the air (OTA).

As previously noted, the applet 112 is configured to send collected profile data to a server and the applet 112 is configured to send immediate responses to the QoE server if the request is an on-demand request.

In configurations, the applet 112 receives the capability request 114 and orders the mobile communication device 102 to send the device profile 118 to the applet 112. The applet 112 collects the device profile 118 and sends the device profile 118 to the QoE server 108. The QoE server 108 processes (maps) the device profile 118 and determines the mobile communication device capabilities based on the mapping. The QoE server 108 then provides the determined device capabilities 120 to the API server 104 (e.g., for engineering purposes) and/or the customer service server 106. The API server 104 and/or the customer service server 106 compares the mobile communication device capabilities 120 to network requirements and makes business decisions with respect to the mobile communication device's operation within the wireless communication network 100. As previously noted, this capability check may be automated for new devices and/or for software and/or firmware updates before launch.

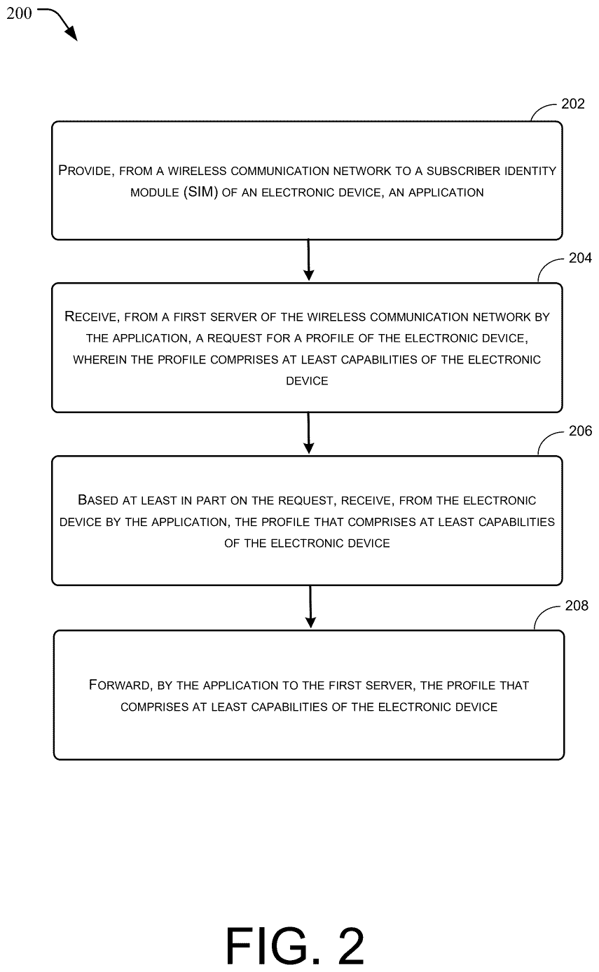

FIG. 2 is a flow diagram illustrating an example method for determining mobile communication device capabilities, e.g., mobile communication device 102, within a wireless communication network, e.g., wireless communication network 100. The process is illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, when executed by one or more processor(s), performs the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

At 202, a wireless communication network provides an application to a subscriber identity module (SIM) of an electronic device. For example, in configurations, the one or more mobile communication device(s) 102 each include a SIM 110 and an applet 112 loaded on the SIM. The applet 112 may be provided by an operator of the wireless communication network 100. The SIM 110 may in the form of a SIM card (pSIM), an embedded SIM (eSIM) or an integrated SIM (iSIM). The applet 112 may be installed on a physical SIM card (pSIM) of the mobile communication device 102 or an embedded SIM (eSIM) of the mobile communication device 102. In configurations, the applet 112 may be moved from an eSIM to another eSIM of another mobile communication device. In configurations, the applet may be installed on an integrated SIM (iSIM) of the mobile communication device 102. In configurations, the applet 112 may be installed on pSIMs, eSIMs, and/or iSIMs over the air (OTA).

At 204, a request for a profile of the electronic device is received by the application from a first server of the wireless communication network, wherein the profile comprises at least capabilities of the electronic device. For example, in configurations, the first server may be the QoE server 108. Furthermore, a second server, such as the API server 104 and/or the customer service server 106 may send a mobile device capability call (request) 114 to the QoE server 108 for a mobile communication device 102. Once the QoE server 108 receives the capability request 114, the QoE server 108 forwards the capability request 114 to the applet 112 on the SIM 110 on the mobile communication device 102. The applet 112 sends a request to a controller 116 of the mobile communication device 102 for a device profile 118, which includes at least capabilities of the mobile communication device 102.

At 206, based at least in part on the request, the application receives the device profile that comprises at least capabilities of the electronic device from the electronic device. For example, the applet 112 receives the device profile 118 and the applet 112 provides the device profile 118 to the QoE server 108. The QoE server 108 saves the device profile 118, e.g., maps the device profile 118 with respect to the mobile communication device 102. The QoE server 108 analyzes or processes the device profile 118 in order to determine device capabilities 120 of the mobile communication device 102.

At 208, the application forwards the profile that comprises at least capabilities of the electronic device from the electronic device to the first server. For example, the application forwards the device profile 118 to the QoE server 108. In some implementations, the QoE server 108 then sends the device capabilities 120 back to the API server 104 and/or the customer service server 106.

Thus, the techniques and architecture described herein provide an application (e.g., an applet) that is installed on a subscriber identity module (SIM) of a mobile device. The applet performs device profile requests from the mobile device, where the device profile includes at least capabilities of the mobile device. The obtained device profile may be stored in a server, e.g., mapped to the server. Logic may be used to process, e.g., analyze, the device profile in order to determine the mobile device's capability. Accordingly, the MNO's customer service can gather mobile device capability and take needed actions with respect to the mobile device. Additionally, knowing a mobile device's capabilities simplifies business decision making and troubleshooting with respect to the mobile device and/or the mobile device's owner. Furthermore, in configurations, a test suite may be run for every new mobile device launched within the mobile network in order to determine device capability matching the MNO's current requirements. Additionally, the MNO can identify and take corrective action(s) if any new or existing mobile device has missing necessary capability.

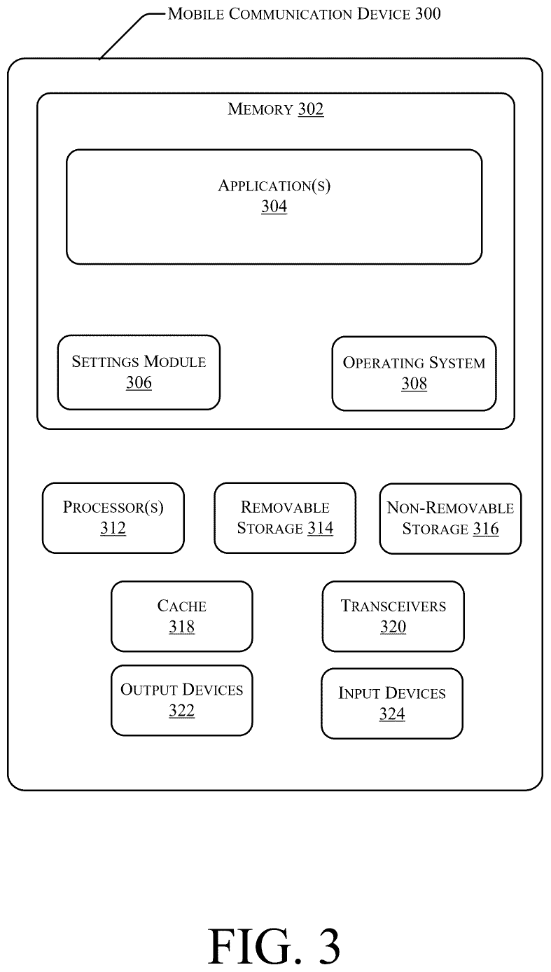

FIG. 3 schematically illustrates a component level view of a mobile communication device 300, such as mobile communication device(s) 102, configured to function within wireless communication networks. As illustrated, the mobile communication device 300 comprises a system memory 302, e.g., computer-readable media, storing application(s) 304, e.g., applet 112. Alternatively, the functions and UIs may be implemented, wholly or in part, via firmware (not illustrated). The mobile communication device 300 also comprises a settings module 306, and an operating system 308. Also, the mobile communication device 300 includes processor(s) 312, a removable storage 314, a non-removable storage 316, cache 318, transceivers 320, output device(s) 322, and input device(s) 324. In various implementations, system memory 302 is volatile (such as RAM), non-volatile (such as ROM, flash memory, etc.) or some combination of the two. In some implementations, the processor(s) 312 is a central processing unit (CPU), a graphics processing unit (GPU), or both CPU and GPU, or any other sort of processing unit.

The mobile communication device 300 may also include additional data storage devices (removable and/or non-removable) such as, for example, magnetic disks, optical disks, or tape. Such additional data storage may include removable storage 314 and non-removable storage 316. Additionally, the mobile communication device 300 includes cache 318.

Non-transitory computer-readable media may include volatile and nonvolatile, removable and non-removable tangible, physical media implemented in technology for storage of information, such as computer readable instructions, data structures, program modules, or other data. System memory 302, removable storage 314, non-removable storage 316 and cache 318 are all examples of non-transitory computer-readable media. Non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other tangible, physical medium which can be used to store the desired information and which can be accessed by the mobile communication device 300. Any such non-transitory computer-readable media may be part of the mobile communication device 300. The processor(s) 312 may be configured to execute instructions, which may be stored in the non-transitory computer-readable media or in other computer-readable media accessible to the processor(s) 312.

In some implementations, the transceivers 320 include any sort of transceivers known in the art. For example, the transceivers 320 may include a radio transceiver that performs the function of transmitting and receiving radio frequency communications via an antenna (not shown). Also, or alternatively, the transceivers 320 may include wireless modem(s) to facilitate wireless connectivity with other computing devices. Further, the transceivers 320 may include wired communication components, such as an Ethernet port, for communicating with other networked devices.

In some implementations, the output devices 322 include any sort of output devices known in the art, such as a display (e.g., a liquid crystal display), speakers, a vibrating mechanism, or a tactile feedback mechanism. Output devices 322 also include ports for one or more peripheral devices, such as headphones, peripheral speakers, or a peripheral display.

In various implementations, input devices 324 include any sort of input devices known in the art. For example, input devices 324 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like. The input devices 324 may be used to enter preferences of a user of the mobile communication device 300 to define how the user wishes certain calls from third parties to be handled by the wireless communication network, as previously described herein.

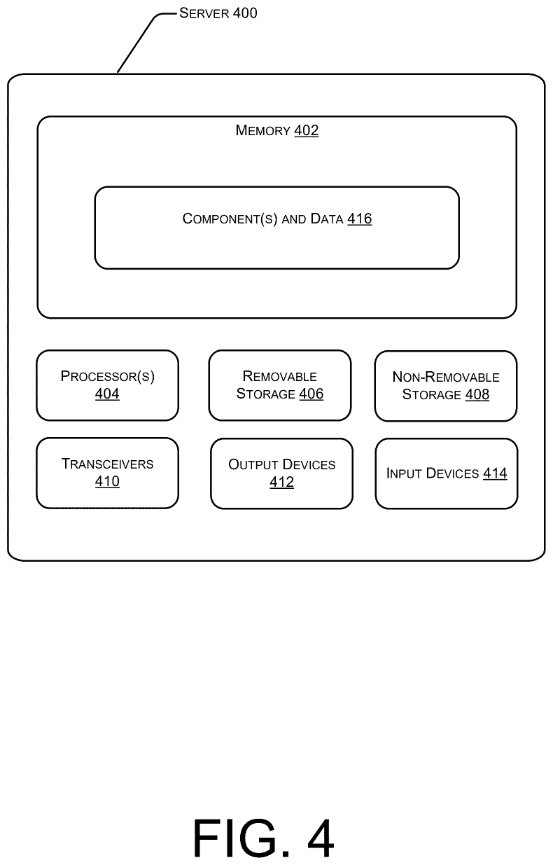

FIG. 4 schematically illustrates a component level view of a server 400 configured for use within a wireless communication network, e.g., wireless communication network 100, in order to provide various services within the wireless communication network, according to the techniques described herein. For example, the server 400 may serve as the API server 104, e.g., one or more servers 400 may be configured to serve as the API server 104. As another example, the server 400 may serve as the customer service server 106, e.g., one or more servers 400 may be configured to serve as the customer service server 106, and/or the server 400 may serve as the QoE server 108, e.g., one or more servers 400 may be configured to serve as the QoE server 108.

As illustrated, the server 400 comprises a system memory 402 that may store one or more components and/or applications and data 416 for interacting with mobile communication devices, e.g., mobile communication device 102, as described herein. Also, the server 400 may include processor(s) 404, a removable storage 406, a non-removable storage 408, transceivers 410, output device(s) 412, and input device(s) 414.

In various implementations, system memory 402 is volatile (such as RAM), non-volatile (such as ROM, flash memory, etc.), or some combination of the two. In some implementations, the processor(s) 404 is a Central Processing Unit (CPU), a Graphics Processing Unit (GPU), or both CPU and GPU, or any other sort of processing unit.

The server 400 may also include additional data storage devices (removable and/or non-removable) such as, for example, magnetic disks, optical disks, or tape. Such additional storage is illustrated in FIG. 4 by removable storage 406 and non-removable storage 408. The one or more of the memory 402, the removable storage 406 and/or the non-removable storage 408 may include module(s) and data 416 (illustrated in the memory 402). The module(s) and data 416 may include instructions executable by, for example, the processor(s) 404.

Non-transitory computer-readable media may include volatile and nonvolatile, removable and non-removable tangible, physical media implemented in technology for storage of information, such as computer readable instructions, data structures, program modules, or other data. System memory 402, removable storage 406 and non-removable storage 408 are all examples of non-transitory computer-readable media. Non-transitory computer-readable media include, but are not limited to, RAM, ROM, EEPROM, flash memory or other memory technology, CD-ROM, Digital Versatile Disks (DVD) or other optical storage, magnetic cassettes, magnetic tape, magnetic disk storage or other magnetic storage devices, or any other tangible, physical medium which can be used to store the desired information and which can be accessed by the server 400. Any such non-transitory computer-readable media may be part of the server 400.

In some implementations, the transceivers 410 include any sort of transceivers known in the art. For example, the transceivers 410 may include wired communication components, such as an Ethernet port, for communicating with other networked devices. Also, or instead, the transceivers 410 may include wireless modem(s) to facilitate wireless connectivity with other computing devices. Further, the transceivers 410 may include a radio transceiver that performs the function of transmitting and receiving radio frequency communications via an antenna.

In some implementations, the output devices 412 include any sort of output devices known in the art, such as a display (e.g., a liquid crystal display), speakers, a vibrating mechanism, or a tactile feedback mechanism. Output devices 412 also include ports for one or more peripheral devices, such as headphones, peripheral speakers, or a peripheral display.

In various implementations, input devices 414 include any sort of input devices known in the art. For example, input devices 414 may include a camera, a microphone, a keyboard/keypad, a computer mouse, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

Some or all operations of the processes described above can be performed by execution of computer-readable instructions stored on a computer storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer storage media may include volatile memory (such as random access memory (RAM)) and/or non-volatile memory (such as read-only memory (ROM), flash memory, etc.). The computer storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer storage medium is an example of computer-readable media. Computer-readable media includes at least two types of computer-readable media, namely computer storage media and communications media. Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer storage media do not include communication media.

The computer-readable instructions stored on one or more non-transitory computer storage media that, when executed by one or more processors, may perform operations described above with reference to FIGS. 1 and 2. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
providing, from a wireless communication network to a subscriber identity module (SIM) of an electronic device, an application;
receiving, from a first server of the wireless communication network by the application, a request for a profile of the electronic device, wherein the profile comprises at least capabilities of the electronic device;
based at least in part on the request, receiving, from the electronic device by the application, the profile that comprises at least capabilities of the electronic device; and
forwarding, by the application to the first server, the profile that comprises at least capabilities of the electronic device.

2. The method of claim 1, further comprising:
based at least in part on the profile, determining, by the first server, capabilities of the electronic device.

3. The method of claim 1, wherein the first server comprises one of (i) a customer service of the wireless communication network server or (ii) an application programming interface (API) server.

4. The method of claim 1, further comprising:
prior to the application receiving the request for the profile of the electronic device, receiving, by the first server from a second server of the wireless communication network, a request for capabilities of the electronic device.

5. The method of claim 4, further comprising:
forwarding, by the first server to the second server, capabilities of the electronic device.

6. The method of claim 5, wherein the second server comprises one of (i) a customer service of the wireless communication network server or (ii) an application programming interface (API) server.

7. The method of claim 1, further comprising periodically performing:
receiving, from the first server of the wireless communication network by the application, the request for the profile of the electronic device, wherein the profile comprises at least capabilities of the electronic device;
based at least in part on the request, receiving, from the electronic device by the application, capabilities of the electronic device; and
forwarding, by the application to the first server, the profile.

8. The method of claim 7, wherein the periodically performing occurs in a range of weekly to monthly.

9. A system comprising:
one or more processors; and
one or more non-transitory computer-readable media storing computer-executable instructions that, when executed by the one or more processors, cause the one or more processors to perform actions comprising:
providing, from a wireless communication network to a subscriber identity module (SIM) of an electronic device, an application;
receiving, from a first server of the wireless communication network by the application, a request for a profile of the electronic device, wherein the profile comprises at least capabilities of the electronic device;
based at least in part on the request, receiving, from the electronic device by the application, the profile that comprises at least capabilities of the electronic device; and
forwarding, by the application to the first server, the profile that comprises at least capabilities of the electronic device.

10. The system of claim 9, wherein the actions further comprise:
based at least in part on the profile, determining, by the first server, capabilities of the electronic device.

11. The system of claim 9, wherein the first server comprises one of (i) a customer service of the wireless communication network server or (ii) an application programming interface (API) server.

12. The system of claim 9, wherein the actions further comprise:
prior to the application receiving the request for the profile of the electronic device, receiving, by the first server from a second server of the wireless communication network, a request for capabilities of the electronic device.

13. The system of claim 12, wherein the actions further comprise:
forwarding, by the first server to the second server, capabilities of the electronic device.

14. The system of claim 13, wherein the second server comprises one of (i) a customer service of the wireless communication network server or (ii) an application programming interface (API) server.

15. The system of claim 9, wherein the actions further comprise periodically performing:
receiving, from the first server of the wireless communication network by the application, the request for the profile of the electronic device, wherein the profile comprises at least capabilities of the electronic device;
based at least in part on the request, receiving, from the electronic device by the application, capabilities of the electronic device; and
forwarding, by the application to the first server, the profile.

16. The system of claim 15, wherein the periodically performing occurs in a range of weekly to monthly.

17. One or more non-transitory computer-readable media storing computer-executable instructions that, when executed by one or more processors, cause the one or more processors to perform actions comprising:
providing, from a wireless communication network to a subscriber identity module (SIM) of an electronic device, an application;
receiving, from a first server of the wireless communication network by the application, a request for a profile of the electronic device, wherein the profile comprises at least capabilities of the electronic device;
based at least in part on the request, receiving, from the electronic device by the application, the profile that comprises at least capabilities of the electronic device; and
forwarding, by the application to the first server, the profile that comprises at least capabilities of the electronic device.

18. The one or more non-transitory computer-readable media of claim 17, wherein the actions further comprise:
based at least in part on the profile, determining, by the first server, capabilities of the electronic device.

19. The one or more non-transitory computer-readable media of claim 17, wherein the actions further comprise:
prior to the application receiving the request for the profile of the electronic device, receiving, by the first server from a second server of the wireless communication network, a request for capabilities of the electronic device.

20. The one or more non-transitory computer-readable media of claim 19, wherein the actions further comprise:
forwarding, by the first server to the second server, capabilities of the electronic device.
